(19) United States
(12) Patent Application Publication
(10) Pub. No.: US 2018/0157459 A1
(43) Pub. Date: Jun. 7, 2018

(54) EAR MONITORING AUDIO

(71) Applicant: Panasonic Automotive Systems Company of America, Division of Panasonic Corporation of North America, Peachtree City, GA (US)

(72) Inventor: DONALD ALLEN TURNER, SENOIA, GA (US)

(73) Assignee: Panasonic Automotive Systems Company of America, Division of Panasonic Corporation of North America

(21) Appl. No.: 15/829,300

(22) Filed: Dec. 1, 2017

Related U.S. Application Data
(60) Provisional application No. 62/428,702, filed on Dec. 1, 2016.

(51) Int. Cl. G06F 3/16; H04R 1/32; H04R 3/12; G06K 9/00

(52) U.S. Cl. CPC G06F 3/165; H04R 1/323; H04R 2499/13; G06K 9/00228; H04R 3/12

(57) ABSTRACT

An audio arrangement for a motor vehicle includes a camera capturing images of a driver of the motor vehicle. A processor is communicatively coupled to the camera and determines, based on the captured images, locations of ears of the driver. An audio system is communicatively coupled to the processor and adjusts a parameter of an audio signal dependent upon the determined locations of the ears of the driver. A loudspeaker is communicatively coupled to the audio system and emits sounds based on the audio signal.

### CROSS-REFERENCED TO RELATED APPLICATIONS

This application claims benefit of U.S. Provisional Application No. 62/428,702 filed on Dec. 1, 2016, which the disclosure of which is hereby incorporated by reference in its entirety for all purposes.

### FIELD OF THE INVENTION

The disclosure relates to an audio system, and, more particularly, an audio system in a motor vehicle.

### BACKGROUND OF THE INVENTION

How music or other audio sounds to a listener in a passenger compartment or cabin of a motor vehicle depends on the exact location of the listener's head/ears within the cabin. However, there are no known audio systems that take ear location into consideration in audio settings.

### SUMMARY

The present invention may use a driver monitor camera to identify the location of a vehicle occupant's ears. The vehicle's sound system may then use that ear location information to customize sound settings, including equalization, phase, speaker directionality, and sound isolation.

In one embodiment, the invention comprises an audio arrangement for a motor vehicle, including a camera capturing images of a driver of the motor vehicle. A processor is communicatively coupled to the camera and determines, based on the captured images, locations of ears of the driver. An audio system is communicatively coupled to the processor and adjusts a parameter of an audio signal dependent upon the determined locations of the ears of the driver. A loudspeaker is communicatively coupled to the audio system and emits sounds based on the audio signal.

In another embodiment, the invention comprises an automotive audio method, including capturing images of an occupant of a passenger compartment of a motor vehicle while he is in the passenger compartment. Locations of ears of the occupant are determined based on the captured images. A parameter of an audio signal is adjusted dependent upon the determined locations of the ears of the occupant. Sounds are emitted based on the audio signal.

In yet another embodiment, the invention comprises an audio arrangement for a motor vehicle, including at least one camera capturing images of a plurality of occupants of the motor vehicle. A processor is communicatively coupled to the at least one camera and determines, based on the captured images, locations of ears of each of the occupants. An audio system is communicatively coupled to the processor and adjusts a parameter of an audio signal dependent upon the determined locations of the ears of the occupants. A loudspeaker is communicatively coupled to the audio system and emits sounds based on the audio signal.

An advantage of the present invention is that it may normalize audio quality across various ear box positions.

### BRIEF DESCRIPTION OF THE DRAWINGS

A better understanding of the present invention will be had upon reference to the following description in conjunction with the accompanying drawings.

FIG. 1 is a block diagram of one embodiment of an ear monitoring audio arrangement of the present invention.

FIG. 2 is a flow chart of one embodiment of an automotive audio method of the present invention.

### DETAILED DESCRIPTION OF THE PREFERRED EMBODIMENTS

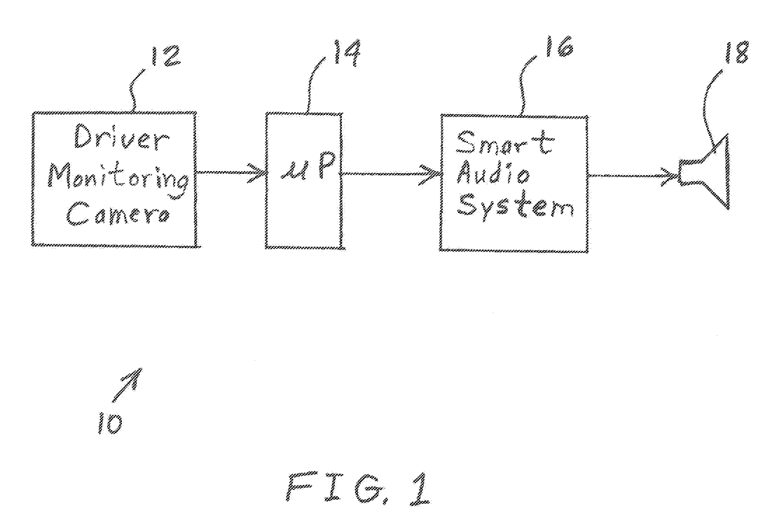

FIG. 1 illustrates one embodiment of an ear monitoring audio arrangement 10 of the present invention, including a driver monitoring camera. 12, an electronic system 14 having a microprocessor, a smart audio system 16, and at least one loudspeaker 18. Driver monitoring camera 12 may capture images of the driver while he is driving and is sitting in the driver's seat in the passenger compartment. Driver monitoring camera 12 may capture images of the driver such that electronic system 14 may ascertain from the images the locations of the driver's ears in three-dimensional space and track the locations as they change with time. More generally, electronic system 14 may process the information captured by driver monitoring camera 12 regarding the driver's ear position.

Based upon the ear location data received from electronic system 14, smart audio system 16 may adjust sound settings, equalization, phase, etc., of the sound emitted by loudspeaker 18. Smart audio system 16 may make these adjustments in order to improve the sound quality, and/or to make the sound more aesthetically pleasing to the driver. As the driver moves his head and ears, the adjustments to audio signal parameters may be performed at least once per second in order to keep up with the changing locations of the driver's ears.

If there are multiple loudspeakers within the passenger compartment of the vehicle, the speakers may be located at spaced out locations with different orientations. Thus, the sound emitted by each of the loudspeakers may be adjusted differently based upon each speaker's location and orientation relative to the driver's ears. It is also possible for a same or similar adjustment to be made to the sound emitted by each speaker.

In another embodiment, one or more cameras capture images of all of the passengers in the vehicle, and the processor determines therefrom the ear positions of all of the passengers. The smart audio system may then adjust sound settings, equalization, phase, etc., of the sound emitted by one or more loudspeakers in order to optimize the sound quality for the passengers as a group, and/or to make the sound more aesthetically pleasing to the passengers as a group.

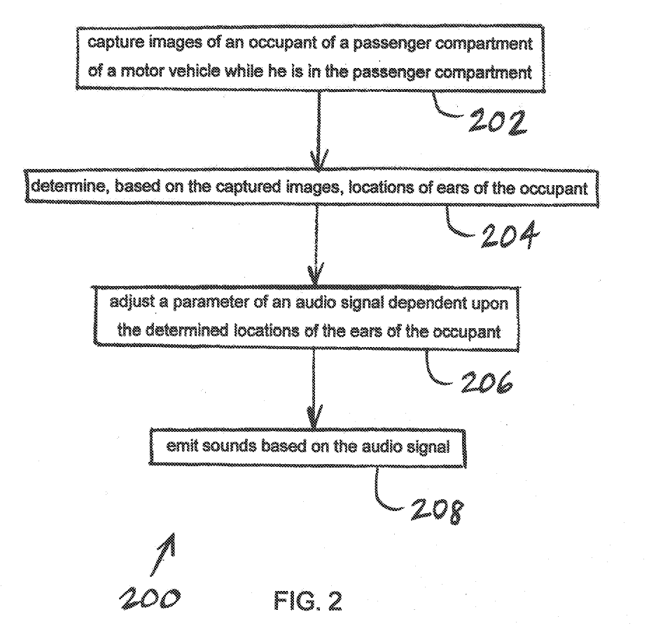

FIG. 2 illustrates one embodiment of an automotive audio method 200 of the present invention. In a first step 202, images of an occupant of a passenger compartment of a motor vehicle are captured while he is in the passenger compartment. For example, driver monitoring camera 12 may capture images of a head of a driver of a motor vehicle while he is in the passenger compartment.

Next, in step 204, locations of ears of the occupant are determined, based on the captured images. For example, electronic system 14 may analyze the captured images and determine therefrom the locations of the ears of the occupant. If the occupant's ears are not visible in the images, then the locations of the ears may be estimated based on the locations of other facial features, such as the eyes, nose and mouth.

In a next step 206, a parameter of an audio signal is adjusted dependent upon the determined locations of the ears of the occupant. For example, based upon the ear location data received from electronic system 14, smart audio system 16 may adjust sound settings, equalization, phase, etc., of the audio signal produced by audio system 16.

In a final step 208, sounds are emitted based on the audio signal. For example, loudspeaker 18 may emit sounds based on the adjusted audio signal produced by audio system 16. The invention has been described as detecting the positions of a driver's ears. However, the invention may detect the positions of the ears of any occupant of the vehicle other than the driver. For example, in the case of an autonomously driven vehicle that has no human driver, the positions of the ears of any or all human passengers of the vehicle may be detected.

The invention has been described as determining the locations of the driver's ears in the captured images. However, it is within the scope of the invention to determine the locations of the driver's ears indirectly based on the location of some other feature of the driver's head, such as his eyes.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. An audio arrangement for a motor vehicle, comprising:
a camera configured to capture images of a driver of the motor vehicle;
a processor communicatively coupled to the camera and configured to determine, based on the captured images, locations of ears of the driver;
an audio system communicatively coupled to the processor and configured to adjust a parameter of an audio signal dependent upon the determined locations of the ears of the driver; and
a loudspeaker communicatively coupled to the audio system and configured to emit sounds based on the audio signal.

2. The audio arrangement of claim 1 wherein the parameter of the audio signal comprises a sound setting, an equalization value, or a phase of the audio signal.

3. The audio arrangement of claim 1 wherein the loudspeaker is configured to emit the sounds into a passenger compartment of the motor vehicle.

4. The audio arrangement of claim 1 wherein the loudspeaker comprises a first loudspeaker of a plurality of loudspeakers, the audio system being configured to adjust a respective parameter of each of a plurality of audio signals dependent upon the determined locations of the ears of the driver and such that each parameter is adjusted differently, each said loudspeaker receiving a respective said audio signal.

5. The audio arrangement of claim 1 wherein the processor is configured to determine, based on the captured images, the locations of the ears of the driver in three dimensions.

6. The audio arrangement of claim 1 wherein the audio system is configured to adjust the parameter of the audio signal with a frequency of at least once per second, the adjusting being dependent upon changes in the determined locations of the ears of the driver.

7. The audio arrangement of claim 1 wherein the processor is configured to determine the locations of the ears of the driver based on the captured images, and based on a location of an other feature of a head of the driver.

8. An automotive audio method, comprising:
capturing images of an occupant of a passenger compartment of a motor vehicle while he is in the passenger compartment;
determining, based on the captured images, locations of ears of the occupant;
adjusting a parameter of an audio signal dependent upon the determined locations of the ears of the occupant; and
emitting sounds based on the audio signal.

9. The method of claim 8 wherein the parameter of the audio signal comprises a sound setting, an equalization value, or a phase of the audio signal.

10. The method of claim 8 wherein the sounds are emitted into the passenger compartment of the motor vehicle.

11. The method of claim 8 wherein the adjusting step includes adjusting a corresponding parameter of each of a plurality of audio signals dependent upon the determined locations of the ears of the driver such that each parameter is adjusted differently, the emitting step including emitting a plurality of sounds each based on a respective one of the audio signals.

12. The method of claim 8 wherein the determining step includes determining, based on the captured images, the locations of the ears of the driver in three dimensions.

13. The method of claim 8 wherein the adjusting step includes adjusting the parameter of the audio signal with a frequency of at least once per second, the adjusting being dependent upon changes in the determined locations of the ears of the driver.

14. The method of claim 8 wherein the determining step is configured to determine the locations of the ears of the driver based on the captured images, and based on a location of an other feature of a head of the driver.

15. An audio arrangement for a motor vehicle, comprising:
at least one camera configured to capture images of a plurality of occupants of the motor vehicle;
a processor communicatively coupled to the at least one camera and configured to determine, based on the captured images, locations of ears of each of the occupants;
an audio system communicatively coupled to the processor and configured to adjust a parameter of an audio signal dependent upon the determined locations of the ears of the occupants; and
a loudspeaker communicatively coupled to the audio system and configured to emit sounds based on the audio signal.

16. The audio arrangement of claim 15 wherein the parameter of the audio signal comprises a sound setting, an equalization value, or a phase of the audio signal.

17. The audio arrangement of claim 15 wherein the loudspeaker is configured to emit the sounds into a passenger compartment of the motor vehicle.

18. The audio arrangement of claim 15 wherein the loudspeaker comprises a first loudspeaker of a plurality of loudspeakers, the audio system being configured to adjust a respective parameter of each of a plurality of audio signals dependent upon the determined locations of the ears of the occupants and such that each parameter is adjusted differently, each said loudspeaker receiving a respective said audio signal.

19. The audio arrangement of claim 15 wherein the processor is configured to determine, based on the captured images, the locations of the ears of the occupants in three dimensions.

20. The audio arrangement of claim 15 wherein the audio system is configured to adjust the parameter of the audio signal with a frequency of at least once per second, the adjusting being dependent upon changes in the determined locations of the ears of the occupants.

21. The audio arrangement of claim 15 wherein the processor is configured to determine the locations of the ears of the occupants based on the captured images, and based on a location of at least one other feature of heads of the occupants.
